(19) United States
(12) Patent Application Publication
(10) Pub. No.: US 2025/0321195 A1
(43) Pub. Date: Oct. 16, 2025

(54) METHOD AND APPARATUS FOR OPTICALLY CHECKING MOLDED PARTS

(71) Applicant: Finatec Holding AG, Brügg b. Biel (CH)

(72) Inventors: Fridolin MAIBACH, Safnern (CH); Matthias HERMLE, Brügg b. Biel (CH); Hansjörg KLOCK, Worb (DE)

(21) Appl. No.: 18/866,812

(22) PCT Filed: May 15, 2023
(86) PCT No.: PCT/EP2023/062872

§ 371 Date: Nov. 18, 2024

(30) Foreign Application Priority Data
May 19, 2022 (CH) 000607/2022

(51) Int. Cl. G01N 21/88; G01B 11/06

(52) U.S. Cl. CPC G01N 21/8851; G01B 11/06; G01N 2021/8861; G01N 2021/8874; G01N 2021/889

(57) ABSTRACT

Method and system for optically checking molded parts (10) in a transmitted light method, more particularly closures or the like produced by thermoforming or compression molding methods, comprising transporting the molded parts (10) from a transport device (50) through an optical checking area, and recording at least one image of the molded part (10) using a recording device (20), whereby the molded part (10) is located between the recording device (20) and an illumination device (30) and is illuminated by same, whereby the image is evaluated using processing means (40) in such a way that defects of the molded part (10) and/or statistical deviations from a normal distribution are able to be determined, from which conclusions are able to be drawn about a manufacturing process of the molded parts (10) in a molding tool having a cavity, whereby the conclusions are able to be used to control the manufacturing process.

### TECHNICAL FIELD OF THE INVENTION

The present invention relates to a method and an apparatus for optically checking molded parts. In particular, molded parts that can be produced in a thermoforming or compression molding process, for example a closure or similar, are checked for defects by means of a transmitted light inspection.

### STATE OF THE ART

Plastic parts can be produced in large quantities and at high speed using known primary molding and forming processes. In particular, molded parts can be produced by thermoforming, compression molding, injection blow molding or injection molding. Most finished plastic parts produced worldwide are manufactured using injection molding, although extrusion with blow molding and film blowing also play an important role. Flawless, high-quality molded parts require the molds and machines to be in good condition and the manufacturing process to be perfectly controlled, which must be checked at all times.

In the injection molding process, plasticized plastic is injected into a mold with at least one cavity using an injection unit. The molded injection-molded parts are removed from the mold and transported away by a conveyor system. In order not only to detect defects in good time, but also to be able to assign them to the corresponding cavity of the mold, it is known to maintain the relative sequential order of the injection molded parts up to an inspection system. If flaws are detected in the inspection system, the cavity from which the faulty injection molded part originates can be identified and corrections can then be made using a selective control system. However, this inspection is problematic in connection with mass-produced molded parts.

An inspection system is known from EP 2 976 204 B1, by means of which an optical inspection of so-called preforms is carried out. The preforms are, for example, preforms of PET bottles or plastic caps, which are inspected for color quality, defects and dimensions. The preforms are conveyed from a transport device to an inspection device and an image of the preforms is taken in free fall or sliding over a plate using an image capture device in order to detect the color quality and/or defective preforms. However, not all defects in the preforms produced can be clearly detected in this way.

In principle, an optical inspection using a transmitted light method is also known, whereby the test specimen to be inspected is arranged between a light source and a recording device. For example, a transmitted light method is known in which the test specimens to be inspected slide over an at least partially transparent plate or a diffuser in the inspection area.

Furthermore, an inspection method and device are known from EP 2 969 269 A, in which fast-moving articles to be treated are taken over by an inspection unit into a conveyor path and at least one control camera records image data of each body. The inspection unit transfers the bodies to a separating unit, the bodies being ejected almost in a free throw are thrown out in such a way that bodies recognized as defective are separated from those recognized as defect-free. The bodies are transported individually past at least one control camera by means of a transport device, whereby the control camera is a daylight camera, an IR camera and/or one or more sensors for detecting color and/or dimensions.

However, it is often not practical to inspect test specimens made of opaque material using the transmitted light method, as the light does not penetrate the test specimen sufficiently. It is also considered a disadvantage that a transmitted light inspection requires fine-tuned coordination with a transport system of the test specimens in the inspection area, which is often difficult to realize.

### SUMMARY OF INVENTION

It is an object of the invention to propose a method for optically checking molded parts, in particular closures or the like which can be produced by thermoforming or compression molding processes, for their quality and/or functionality, in which the aforementioned disadvantages of the known processes are avoided or at least greatly reduced. Furthermore, a system is described which is suitable for carrying out this method.

In particular, the object of the invention is to propose a method and the corresponding system for the optical inspection of molded parts, by means of which a reliable, fast and very simple inspection is possible, based on a virtually reflection-free image. On the basis of the virtually reflection-free image of the molded part, multiple defects and/or imperfections can be detected at an early stage, even in areas that are difficult to detect and already as a tendency, which cannot be detected or can only be detected inadequately using other methods. The shaping device, the molding tool used and/or the material can be responsible for the faults, defects and/or imperfections as well as changes. The complex interplay between the design of the molded part and the molding tool as well as between the properties of the material and various process parameters leads to a wide range of defects that can render the manufactured molded part unusable.

By means of the reliable inspection of molded parts for multiple defects and/or analysis of statistical data of the entirety of the molded parts, i.e. a large amount of data, conclusions can be drawn about process defects during production, so that the manufacturing process can therefore also be checked and regulated or controlled. The manufacturing process can be optimized with a closed-loop and/or control system based on an evaluation of the detected defects or statistical data.

These objects are achieved according to the invention through the subject matter of the independent claims. Further advantageous embodiments emerge moreover from the dependent claims and the description.

The objects of the present invention are achieved in that the method enables optical checking of molded parts by means of optimum illumination in the form of transmitted light or backlighting. In particular, the objects are achieved by a method for optically checking molded parts by transmitted light, in particular closures or the like produced in a manufacturing process by thermoforming or compression molding. The method comprises transporting the molded parts from a transport device through an optical inspection area and recording at least one image of the molded part by means of a recording device, the molded part being located between the recording device and an illumination device and being illuminated by the latter. The image is evaluated by processing means in such a way that defects in the molded part and/or statistical data can be determined, from which conclusions can be drawn about the manufacturing process of the molded parts in a mold with a cavity, which can be used to control the manufacturing process. For example, process parameters can be adjusted accordingly.

An image of the molded part taken by a recording device in backlight suppresses or minimizes reflections on the surface of the molded part so that the image taken can be easily evaluated by a processing device. Depending on the color of the molded part, the entire wall can therefore be inspected so that defects in the wall, in an inner zone and/or on the opposite side can also be detected.

The image is evaluated by the processing device in order to check the molded part for defects. Furthermore, the amount of data that can be captured can be statistically evaluated using algorithms, for example to detect deviations from a normal distribution and/or patterns from which further conclusions can be drawn and predictions made. The evaluation can make use of customizable algorithms.

Detectable defects allow conclusions to be drawn about the manufacturing process itself, so that process parameters of the manufacturing process can be adjusted accordingly. However, not only detectable defects can be used to monitor and/or control the manufacturing process, but the analysis and evaluation of the entirety of the molded parts can be used according to the invention. Data from the inspected molded parts, including the molded parts identified as defective and the molded parts identified as defect-free, can be analyzed using algorithms and/or artificial intelligence in order to identify deviations from the normal distribution of the entirety of the inspected molded parts and/or patterns from statistical data. The analysis therefore allows trends to be recognized at an early stage. This can be counteracted by correcting the process parameters of the manufacturing process at an early stage.

In particular, the evaluation and/or control of the manufacturing process can be based on artificial intelligence or suitable algorithms. Accordingly, rapid adaptation to changing conditions can be achieved, which is only possible to a limited extent in a conventional parameterizable system. This means that errors and/or trends that cannot be predicted can also be detected effectively.

The lighting device can be set up to guide direct and/or indirect light through the molded part so that the recording device can record at least one image of the molded part on the side of the molded part opposite the light source. A light plate and the use of polarized light, a diffuser or co-axial light are particularly suitable. However, homogeneous illumination of the molded part is also possible by means of dome lighting, i.e. dome-shaped lighting, in particular multicolor dome lighting, while avoiding reflections of the molded part located between the light source and a recording device. Furthermore, several light sources with different light properties, for example IR, UV and/or X-ray radiation, etc., can also be used.

According to the invention, test specimens which can be produced as molded parts in an upstream thermoforming or molding process are subjected to optical testing using the transmitted light method. The molded parts are in particular closures and/or caps or preforms as well as plastic containers in general. In particular, the inner zone of a molded part designed as a closure can be inspected in backlighting for a wide variety of defects from which process errors can be inferred.

Defects can be inclusions, which can occur in the form of air pockets, foreign bodies such as dust, dirt and/or metal particles as well as prematurely solidified material. Included cooled material, also referred to as a cold plug, occurs in particular in the area of an injection or sprue point and is recognizable in thin-walled or transparent molded parts as comet-tail-shaped markings or by locally concentrated streaks. Air inclusions, which can be traced back to air trapped by the molten material, show a varying defect pattern. This can result in defects due to areas not filled with material, bubbles, pinholes, blowholes and/or dark spots on the surface of the molded part or, in the case of transparent materials, thermal damage on the inside. Air inclusions can occur if the air present in the mold does not escape quickly enough, for example if ventilation ducts are blocked. Based on detectable inclusions, conclusions can be drawn about the manufacturing process.

In one embodiment of the invention, the entire surface of the molded part is inspected for defects and/or deviations in an optical inspection using the transmitted light method. Of particular interest here is the area of the sprue or injection point, which is difficult to inspect using the incident light method.

In a further embodiment of the invention, the optical inspection of the molded part is carried out by transmitted light along flow lines in order to detect defects, including color deviations, streaks, holes and/or cracks, which allow conclusions to be drawn about the manufacturing process of the molded part.

A color deviation can occur in particular after a color change of the material used, the so-called master batch. In injection molding processes, the old color may still be detectable in or on the molded part after many cycles following a color change, often visible along flow lines. However, color streaks can also be caused by an uneven distribution of pigments in the material. One of the causes of such color streaks can be the wear of a tool insert known as a “gate insert”. Particularly in the case of translucent colors, which are becoming increasingly popular, such color streaks are easily recognizable and cause rejects. Early replacement of the tool insert reduces rejects.

The appearance of streaks can occur in several forms and for different reasons. Water in various aggregate states as a component of the material leads to cloud formation, water marks and/or moisture streaks. This can be caused by the fact that the material used tends to absorb water, the humidity is too high, the tool wall is too cold or the temperature at the material inlet is not correct. Water in a leaking water cooling system can also be detected via defects. In addition, burn marks can occur owing to severe thermal damage to the material. This can be caused by thermal damage to the molten material due to oxidation and/or material decomposition due to strong friction. This may indicate incorrect venting. Air streaks can also occur.

Other detectable defects can take the form of shear marks caused by a pulsating material flow, the so-called diesel effect, gloss differences, etc.

Detectable holes as defects, in particular micro-holes, so-called pin-holes, indicate that deposits may be present in the area of the injection point. These micro-holes have an influence on the tightness of an injection-molded closure and are an important quality criterion. In contrast to known methods of detecting these micro-holes by means of a high-voltage test, the method according to the invention represents a significant simplification. However, it is also possible to detect not only actual holes but also indentations.

Cracks, for example microcracks and/or stress cracks, can also be detected using the transmitted light method. Stress cracks occur as internal and/or external cracks caused by local stress.

Indentations on the surface of the molded part can also be detected using transmitted light inspection, as can domes, which can also be produced as deposits in an upstream hot channel due to unmelted material, for example.

If the visual inspection of the molded part shows a protrusion, i.e. a burr, it can be concluded that the molten material has penetrated into gaps or joints that are located in the parting lines of the tool and thus do not close these sufficiently tightly.

In a further embodiment of the invention, the molded part is subjected to an optical inspection using the transmitted light method in order to detect engravings, markings, etc., in particular on a top plate of a closure cap. The transmitted light method permits a virtually reflection-free optical inspection with optimum illumination, so that the function and quality of the molded part can be determined by means of image processing. In particular, a cavity number of the production tool, the so-called nest number, can be clearly identified with this setup. Furthermore, depending on the color of the molded part material, defects can be detected inside the closure and on the opposite side.

Furthermore, according to one embodiment, the geometry of the molded part is inspected during the optical inspection using the transmitted light method. Particular attention is paid to functionally relevant areas, for example sealing elements and/or threaded areas. Defects on the sealing elements, for example notches or missing material, can render a closure unusable.

A detectable deviation in the geometry of the actual molded part from the ideal shape can include distortion, twisting, warping and/or angular deviation. Preferably, differences in wall thickness, which are of decisive importance for the sealing function, can be detected using the transmitted light method and thus almost reflection-free.

In particular, defects can occur in the area of the injection point, which can be easily inspected using the transmitted light method. Preferably, the geometry and in particular a diameter of the injection point is determined during the optical inspection of the molded part using the transmitted light method, which allows conclusions to be drawn about the manufacturing process. If possible, the injection point is positioned on the molded part in such a way that the molten material enters the mold strategically and as evenly as possible. For a rotationally symmetrical closure, it is necessary that the outside and inside of the closure are coaxial in order to have a uniform wall thickness. Unequal wall thicknesses have a negative influence on the tightness of the closure. The position and/or shape of the injection point can therefore be used as a quality criterion.

A further embodiment of the present invention relates to the optical inspection of a test specimen produced in a multi-part mold using the transmitted light method. Even if the tool halves of a mold are exactly centered in relation to each other, a so-called core shift can occur. An unbalanced mold filling can result in a shift of the core, whereby the shift leads to deviating wall thicknesses in the molded part. In particular, if the molded part is a closure cap, the core shift leads to a relative displacement from the outside to the inside of the closure cap. An uneven wall thickness has a negative effect on the tightness and/or represents a weak point that influences the functionality.

For various reasons, molded parts may deviate from the desired geometry, for example in terms of diameter and/or ovality or roundness, as examples of geometric defects. In an advantageous embodiment, the outer diameter of a molded part is measured during the optical inspection of the molded part using the transmitted light method and set in relation to the diameter of an inner seal diameter. For example, the ratio that can be determined can be used to draw conclusions about the ovality of the sealing diameter of a rotationally symmetrical molded part, e.g. a cap, which influences the tightness of the molded part designed as a screw cap. If this ratio is outside a definable tolerance, process parameters are corrected or the mold is checked.

In an advantageous embodiment of the invention, the method is set up to carry out an optical inspection of the molded parts produced in a manufacturing process in line with the latter using the transmitted light method. Here, the method according to the invention can be oriented to the timing of the manufacturing process in terms of the inspection time required for the optical checking. Accordingly, the process can be carried out at high speed or at a speed independent of the manufacturing process.

The present invention also relates to a system for carrying out the method according to the invention. The system comprises a transport device for moving the molded parts along a transport path into an inspection area for optical inspection using the transmitted light method. The transport device is designed to guide the molded parts smoothly past the recording device and to avoid pendulum movements or inclined positions. The transport device can have two driven and pretensioned belts, each rotating around a drive wheel and a further wheel, which define a conveyor path between them. The width of the conveyor path can be slightly smaller than the free outer diameter of the molded part. In this way, the molded parts can be guided smoothly and without damage with sufficient clamping force and at high transport speeds, whereby the molded parts are guided in a torsion-resistant manner and an unambiguous visual inspection is possible. Both the rotation speeds of the two belts and the type of belt can be different. Furthermore, the number and type of drive wheels can be varied, which can also be pre-tensioned using appropriately designed means. Alternatively, the transport device can comprise one or more star wheels. The inspection area has the recording device and an illumination device, which are arranged in such a way that the molded part is located between the recording device and the illumination device during imaging. Accordingly, the image quality can be increased to ultimately enable improved evaluation of the images.

Advantageously, at least one illuminator is positioned behind a projection surface or plate so that molded parts are illuminated from behind in relation to the recording device. In this way, the molded parts can be optimally illuminated during the optical inspection, allowing various defects and/or flaws to be easily and accurately detected. In addition, the transmitted light method can be combined with a reflected light method, which has further advantages.

It should be mentioned once again that the present invention also relates to a corresponding system in addition to the inventive method described above for testing test specimens using the transmitted light method.

Further details of the invention emerge from the following description of the preferred embodiments, which are shown by way of example in the accompanying drawings. Further advantages of the present invention can be gleaned from the description, as well as suggestions and proposals as to how the subject matter of the invention can be modified or also further developed within the scope of what is claimed.

### BRIEF DESCRIPTION OF THE DRAWINGS

### Shown are:

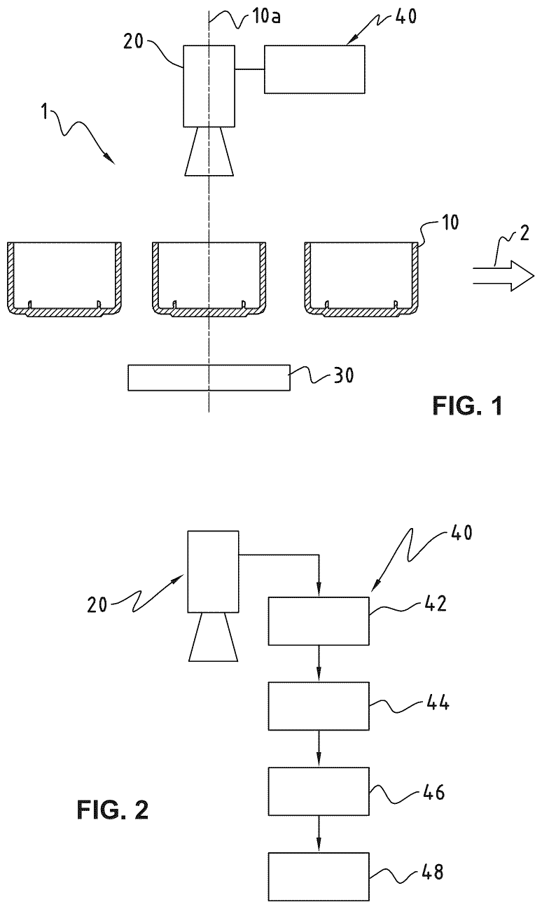

FIG. 1: a schematic representation of an inspection area for an optical checking of a molded part using the transmitted light method,

FIG. 2: a schematic flow chart of the processing of the images to verify defects;

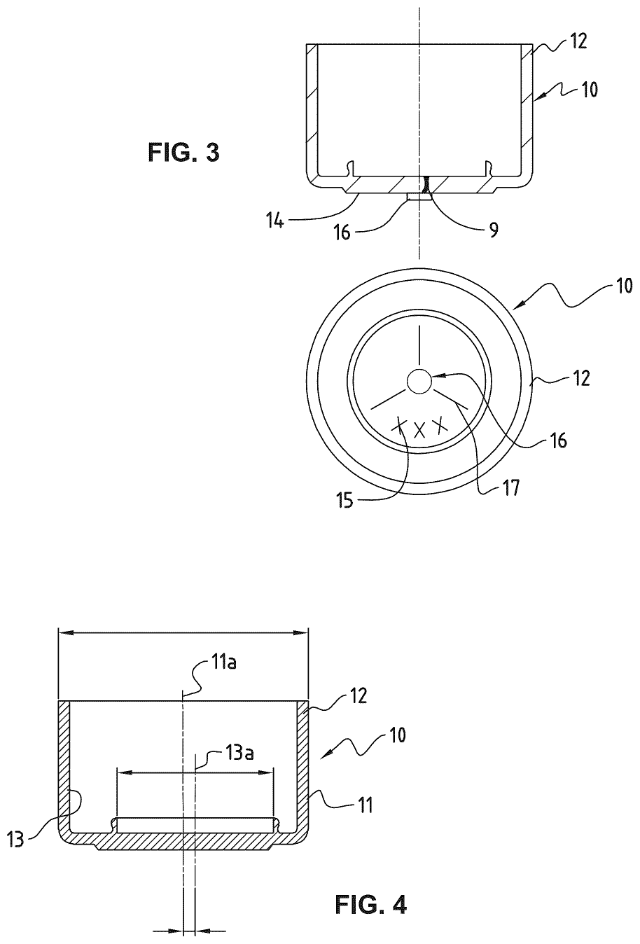

FIG. 3: a schematic representation of detectable defects using the example of a closure;

FIG. 4: a schematic representation of a core offset using the example of a closure;

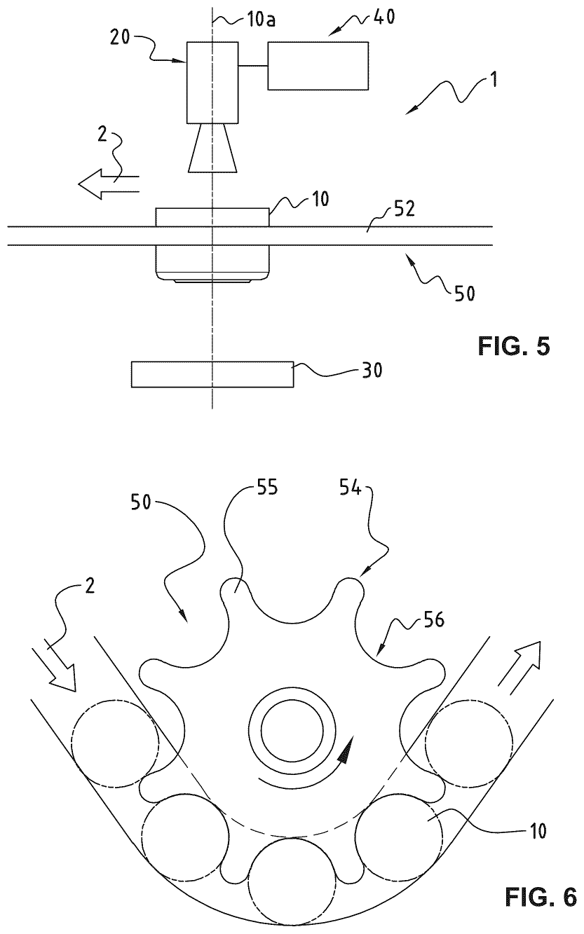

FIG. 5: a schematic representation of a transport device for guiding a molded part through a test that can be carried out using the transmitted light method;

FIG. 6: a schematic representation of a further transport device.

### PREFERRED EMBODIMENTS OF THE INVENTION

FIG. 1 schematically shows an optical inspection area for an optical checking of a molded part 10 using a transmitted light method. The system 1 for optical checking of a molded part 10 comprises a transport device (not shown) for transporting the molded parts 10 in a transport direction indicated by arrow 2. In particular, the molded parts 10, which are shown as an example in the form of sealing caps in FIG. 1, can pass through the optical inspection area in a defined orientation and in sequence. In particular, the molded parts 10 can be introduced individually into the optical checking area, whereby this can be done using a suitable transport device. The closures designed as molded parts 10 can be in the form of a hollow cylindrical body closed on one side, comprising a lower part with an internal thread and possibly a guarantee band, which is molded onto the lower part via webs. Furthermore, the molded part 10 can have one or more printed markings, which can be checked, for example, in accordance with the invention.

At least one recording device 20 is provided in the optical inspection area, which is set up to create at least one image of the molded part 10. As shown, the recording device 20 can comprise a camera arranged above the molded part 10 and optionally filter elements (not shown), so that its optical axis is oriented parallel to the molded part axis 10a of the tested molded part 10. The optical axis of the camera runs approximately through the center of the rotationally symmetrical shaped part 10. An illumination device 30 is arranged opposite the recording device 20 in order to generate transmitted light. The transmitted light preferably extends parallel to the optical axis in the direction of the recording device 20. Accordingly, the molded part 10 to be inspected is located at least temporarily between the recording device 20 and the illumination device 30 in the optical checking area. The optical inspection can therefore be carried out using the so-called transmitted light method, which is advantageous compared with other methods. The transmitted light method is particularly suitable for taking an image without interfering reflections of the molded part 10 passing through the optical checking area. For example, inclusions can be detected inside the molded part 10, which allow conclusions to be drawn about the manufacturing process of the molded part 10, for example an injection molding process. These detectable inclusions allow process parameters to be changed after processing and evaluation and analysis in a processing unit, for example a processor and other components. In the following, reference number 40 refers to a processing unit by means of which the recorded image of the molded part is processed and evaluated for testing and data is analyzed. Based on this, definable process parameters of the manufacturing process can be adjusted. The image recorded by the recording device 20 can be subjected to appropriate processing or analysis by means of an image processing device in order to detect or determine multiple defects in the molded part 10 and statistical data. An algorithm can be used to evaluate the images or for statistical data evaluation, which can be adapted or selected to suit the molded parts 10 to be inspected.

For the transmitted light method, the at least one illumination device 30 can be set up to optimally illuminate the molded part 10 directly or indirectly while the image is being captured. Accordingly, an illuminator can be positioned behind a projection surface or plate of the illumination device 30 in order to enable optimum illumination without disturbing reflections on a molded part surface. For example, a light plate and the use of polarized light, a diffuser and/or coaxial light are suitable. In principle, it is conceivable that, in addition to the positioned illumination device 30 shown in FIG. 1, other illumination devices can also be arranged, which additionally or alternatively also allow optical inspection of the molded parts 10 using the incident light method.

FIG. 2 shows in purely abstract terms that the images recorded by the recording device 20 are processed and analyzed so that the resulting knowledge can be used to adjust the manufacturing process. Processing means 40 for processing and evaluating images of the molded parts 10 are shown schematically in FIG. 2. The processing means 40 comprise a processor 42 which evaluates the image recorded by the recording device 20 or the plurality of recorded images in order to detect defects and/or to collect and analyze statistical data from the entirety of the images. For this purpose, the processor 42 can include an image processing device which subjects the recorded images to appropriate processing, which is necessary in order to be able to detect the defects in the molded part 10 and/or in order to detect any statistical deviations even from defect-free molded parts. These defects can be, for example, inclusions in the form of air pockets, foreign bodies and/or solidified material, which can be detected in the interior and/or in the walls of the molded parts 10. In addition or alternatively, defects in the form of color deviations, streaks, holes, indentations, burns, foreign material and/or cracks can be detected. Any existing engravings and/or markings can also be checked. As will be explained below, the area of the injection point, which experience has shown to be particularly susceptible to defects, can be checked in particular. A significant defect or fault relates to the so-called core shift and different wall thicknesses, which impair the tightness of the molded part 10 designed as a closure. Core offset, also known as core shift, can occur if the mold halves are not exactly aligned with each other during the injection molding process. In the case of closures, the outer side is therefore not centered to the inner side. This results in different wall thicknesses, which have a negative effect on the tightness.

For example, an analog-to-digital conversion may be required to process and evaluate the captured images. The processing means 40 therefore use algorithms which can vary depending on the type of molded part 10. After so-called pre-processing in a processing unit 44, which comprises a known image processing as well as a statistical analysis also using artificial intelligence or algorithms, the information thus obtained can be converted into control parameters for the manufacturing process or into corrected process parameters. These determinable control parameters are then transmitted to a control unit 46 of the manufacturing process, which uses them to generate process parameters in a transformation unit 48. In other words, process parameters of the manufacturing process or the injection molding machine are adapted based on the data that can be determined by means of the processing unit 44. For this purpose, statistical data and/or real-time data are exchanged between the processing unit 44 and the control unit 46 in order to be able to detect trends, patterns and/or accumulations of defects at an early stage. This can be counteracted by adjusting the process parameters or control variables of the manufacturing process in good time in order to avoid large quantities of rejects. FIG. 3 shows various defects to be detected using the example of a molded part 10 designed as a closure. The molded part 10 largely has the shape of a cylindrical hollow body closed on one side and can be designed as a screw cap for bottles. Such closures are mass-produced in an injection molding machine from plastic, e.g. polyethylene, polypropylene or PET (polyethylene terephthalate). As already shown in FIG. 1, the molded parts 10 are conveyed into the optical inspection area separated and arranged, i.e. lying on their end face 14. In the sectioned side view of the molded part 10, a wall 12 is visible, whereby a defect 9 is indicated in the closed end face 14. These may be microcracks, which are only indicated in FIG. 3. Furthermore, conclusions about the manufacturing process can be drawn from the appearance of an injection point 16. An off-center injection point 16 on a rotationally symmetrical molded part 10 can indicate a core shift and thus an incorrect positioning of the injection mold halves. The injection point 16 is an area in which defects such as micro-cracks, micro-holes, etc. occur more frequently. From the top view shown in FIG. 3, both the injection point 16 and streaks 17, in particular color streaks and/or moisture and/or air streaks, as well as indentations or, for example, markings in the form of the so-called cavity or nest number 15 are shown as examples of defects or information that can be easily detected using the transmitted light method.

FIG. 4 shows the core offset on a molded part 10 designed as a closure. Here, the outer side 11 and the inner side 13 are not centered. This can be caused by a shift of the core under the injection pressure and/or an asymmetrical injection of the injection material and/or pressure differences and/or temperature differences on opposite mold walls. A displacement can also be caused by an unclean installation and/or exact mechanical adjustment of the mold halves. This results in uneven wall thicknesses. This is indicated in FIG. 4 by an offset of an axis 11a assigned to the outer side 11 and an axis 13a assigned to the inner side 13.

FIG. 5 shows schematically how a molded part 10 passes through the optical checking area between the recording device 20 and the illumination device 30 in the transport direction 2 and is inspected using the transmitted light method. A transport device 50 is provided for this purpose, which allows the molded part 10 to be inspected or checked to be transported. In the illustrated embodiment example, the transport device 50 can comprise two parallel conveyor belts 52, which engage laterally on the molded part 10.

FIG. 6 shows a schematic detailed view of a transport device 50 in the form of a star wheel 54, which is conceivable in connection with an optical inspection that can be carried out using the transmitted light method. The star wheel 54 comprises several fingers 55, which form pockets 56 between them. The molded parts 10 can be continuously fed by means of a conveyor belt (not shown) and brought into engagement with the pockets 56 of the star wheel 55. Accordingly, the pockets 56 at least partially enclose the molded parts 10. The molded parts can optionally be held in the pockets 56 by means of vacuum and inspected in this held position by transmitted light. Subsequently, the molded parts 10 can be released from the pockets 56 and can be fed to further stations.

In the example shown, the star wheel 54 rotates counterclockwise at an adjustable rotational speed.

Alternatively, the molded parts 10 can slide over an at least partially transparent plate in order to be able to inspect the bottom area of the molded parts 10.

1. Method for optically checking molded parts in a transmitted light method, more particularly closures or the like produced by thermoforming or compression molding methods in a manufacturing process, comprising
transporting the molded parts from a transport device through an optical checking area, and
recording at least one image of the molded part using a recording device, whereby the molded part is located between the recording device and an illumination device and is illuminated by same,
whereby the image is evaluated using processing means in such a way that defects of the molded part and/or statistical data are able to be determined, from which conclusions are able to be drawn about a manufacturing process of the molded parts in a molding tool having a cavity, whereby the conclusions are able to be used to control the manufacturing process.

2-15. (canceled)

16. Method for optically checking molded parts according to claim 1, wherein customizable algorithms are able to be used for the evaluation.

17. Method for optically checking molded parts according to claim 1, wherein inclusions in the form of air pockets, foreign bodies and/or solidified material are able to be detected.

18. Method for optically checking molded parts according to claim 1, wherein the optical checking of the molded part is carried out using the transmitted light method for the entire surface of the molded part.

19. Method for optically checking molded parts according to claim 1, wherein the optical checking of the molded part is carried out by transmitted light along flow lines in order to detect defects in the form of color deviations, streaks, holes, depressions, burns, foreign material and/or cracks.

20. Method for optically checking molded parts according to claim 1, wherein the optical inspection is able to be used in the transmitted light method to detect streaks after a color change in the material.

21. Method for optically checking molded parts according to claim 1, wherein detectable streaks are able to be traced back to material properties, temperature of the process and/or to a leaky temperature control system of a mold.

22. Method for optically checking molded parts according to claim 19, wherein the detectable depressions and/or holes are in the form of micro-holes which can be traced back to deposits in the mold in the region of an injection point.

23. Method for optically checking molded parts according to claim 1, wherein the optical checking using the transmitted light method is able to be used to detect and check engravings and/or markings on the molded part.

24. Method for optically checking molded parts according to claim 1, wherein optical checking using the transmitted light method is able to be used to determine the placement and shape of an injection point.

25. Method for optically checking molded parts according to claim 1, wherein the optical checking using the transmitted light method is able to be used to check the uniformity of wall thicknesses of the molded part and/or to check for a core shift.

26. Method for optically checking molded parts according to claim 1, wherein the optical checking using the transmitted light method is able to be used to detect ovality and/or other geometric defects of the molded part.

27. Method for optically checking molded parts according to claim 1, wherein the optical inspection is able to be carried out using the transmitted light method in combination with an incident light method and/or in line with the manufacturing process of the molded parts.

28. System for optically checking molded parts according to a method according to claim 1, comprising a transport device for transporting the molded parts into an optical checking area, a recording device for producing an image of the molded part and processing means, to which the image can be transmitted for checking, and an illumination device for checking the molded part during the optical check using the transmitted light method, wherein defects of the molded part and/or statistical data are able to be determined.

29. System for optically checking molded parts according to claim 28, wherein the illumination device is provided to illuminate the molded part directly or indirectly during the recording of the image.

30. System for optically checking molded parts according to claim 28, wherein the molded parts are transported into the optical checking area by side belts or guided by a star wheel.
